(19) United States
(12) Patent Application Publication
(10) Pub. No.: US 2016/0130850 A1
(43) Pub. Date: May 12, 2016

(54) TAMPER RESITANT HINGE PIN RETENTION

(71) Applicant: Duncan Bolt Co., Santa Fe Springs, CA (US)

(72) Inventors: Kevin Mohr, Norwalk, CA (US); Carmen Guy Vertullo, San Diego, CA (US)

(73) Assignee: Duncan Bolt Co., Santa Fe Springs, CA (US)

(21) Appl. No.: 14/539,958

(22) Filed: Nov. 12, 2014

(51) Int. Cl. E05D 5/12; E05D 3/02

(52) U.S. Cl. CPC E05D 5/128; E05D 3/02

(57) ABSTRACT

A pin can be retained in a hinge or other set of workpieces by a ferrule crimped onto an annular notch near the terminus of the pin. The ferrule can have a flange that acts as a stop preventing the pin from being removed from the workpieces. With appropriate length of the ferrule and location of the notch, a particular desired degree of play can be introduced. One use of this fastener assembly can be to join two or more workpieces in a way that provides for the workpieces to pivot around the pin.

### FIELD

This concerns fasteners, including those for retaining pins in hinges.

### BACKGROUND

Most applications of two-part type fastener assemblies provide a desired tension to joined workpieces. Lock bolts, for example, are a specialized type of fastener specifically designed to provide a predetermined amount of stress to the workpieces. Other fastener applications, including hinge pins, require fasteners that allow some relative movement between joined workpieces and therefore do not exert significant, or any, tension on the workpieces and may intentionally provide a predetermined amount of play. A separate issue with many fastener systems is the degree of difficulty required to fasten and un-fasten. In much application the combination of quick and accurate fastening with tamper resistant unfastening is desirable.

### SUMMARY

These teachings involve fastener assemblies, components, and methods that address the need for fasteners that provide a rapid assembly and tamper resistant disassembly by the crimping of a ferrule into an annular notch on a pin. This is done in such a way that the ferrule's post-crimp configuration results in the pin not being readily removable from its installation.

### BRIEF DESCRIPTION OF THE DRAWINGS

Embodiments of the invention are illustrated by way of example and not by way of limitation in the accompanying drawings and descriptions.

FIG. 1A is an exploded perspective view of a hinge, a hinge pin with an annular notch, and a ferrule with a flange;

FIG. 1B is an assembled view of the components of FIG. 1 with the ferrule crimped into the annular notch;

FIG. 2A shows a schematic cut-away view of the apparatus of FIG. 1A, assembled but not crimped; and also includes a representation of a crimp die set;

FIG. 2B shows the apparatus and view of FIG. 2A with the ferrule crimped;

FIG. 2C is a simplified top view of the crimping die set of FIG. 2A;

FIG. 2D is a side view of 2C showing the thickness of the crimping die;

FIG. 3A is a side view of the pin of FIG. 1A;

FIG. 3B is a perspective view of the ferrule of FIG. 1A;

FIG. 3C is a bottom view of the ferrule of FIG. 1A;

FIGS. 3D and 3E show a perspective view of a configuration being assembled where the pin is recessed into the sleeve for increased tamper resistance;

FIG. 4A illustrates a ferrule having a flange being placed into a crimp tool;

FIG. 4B illustrates a crimp tool with inserted ferrule being raised up to be installed;

FIG. 4C illustrates an assembled hinge with ferrule crimped on pin;

FIG. 5A is a schematic, cut-away drawing of two workpieces joined by a pin and ferrule with the ferrule not yet crimped;

FIG. 5B is a schematic drawing of the view and apparatus of FIG. 4A with the ferrule in a crimped state;

FIG. 6A is a schematic cut-away drawing of two workpieces joined by a pin and an alternate ferrule not having a flange;

FIG. 6B is a schematic drawing of the view and apparatus of FIG. 5A with the ferrule in a crimped state;

FIG. 7A shows a side view of an alternate pin configuration where the pin shaft is not of a single constant diameter;

FIG. 7B shows a side view of an alternate pin configuration where the pin has multiple positions for ferule retention;

FIG. 8 shows a perspective view of an application in a clevis;

FIG. 9A shows a perspective view of a toy axle with wheels retained by crimped ferrules;

FIG. 9B shows a top view of the toy axle with wheels of FIG. 9A;

FIG. 9C shows an exploded view of the toy axle with wheels of FIG. 9B;

FIG. 10A is a partial perspective view of an eyeglass frame showing a hinge area;

FIG. 10B is an expanded cross section of the hinge and hinge pin of FIG. 10A.

### DETAILED DESCRIPTION AND TEACHING

The fasteners described here span a wide range of sizes and applications but are initially described in their capacity to act as a hinge pin. In many hinge applications two independently provided bodies, each constituting one side, or leaf, of a hinge, are brought together to be joined by the hinge pin. The two leafs' knuckles are appropriately aligned and then a cylindrical pin with a head is dropped into the pivot point intersection of the hinge leafs. In some applications the pin should be positively retained due to vibration, the action of gravity, etc. Some applications requiring positive retention also require a retention secured against extreme and long lasting vibrations while others require a tamper resistant retention.

### Hinge Assembly—First Embodiment

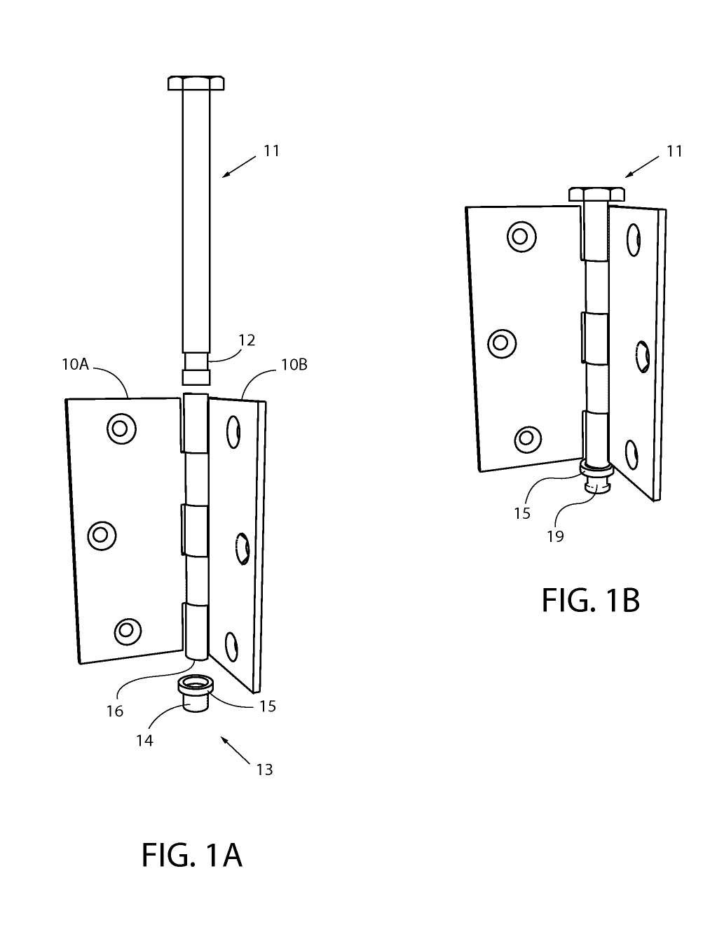

FIG. 1A shows an exploded hinge with two leafs 10A 10B, a hinge pin 11, and a ferrule 13. In this embodiment the ferrule is a bushing with a flange 15 on a sleeve 14. In FIG. 1B the apparatus is seen assembled with the ferrule crimped on to the pin. This crimping has resulted in a non-elastic deformation 19. By having a flange of a sufficiently larger diameter than the diameter of the lowermost part 16 of the hinge leaf 10B (seen in FIG. 1A), the retention of the ferrule causes the retention of the hinge pin.

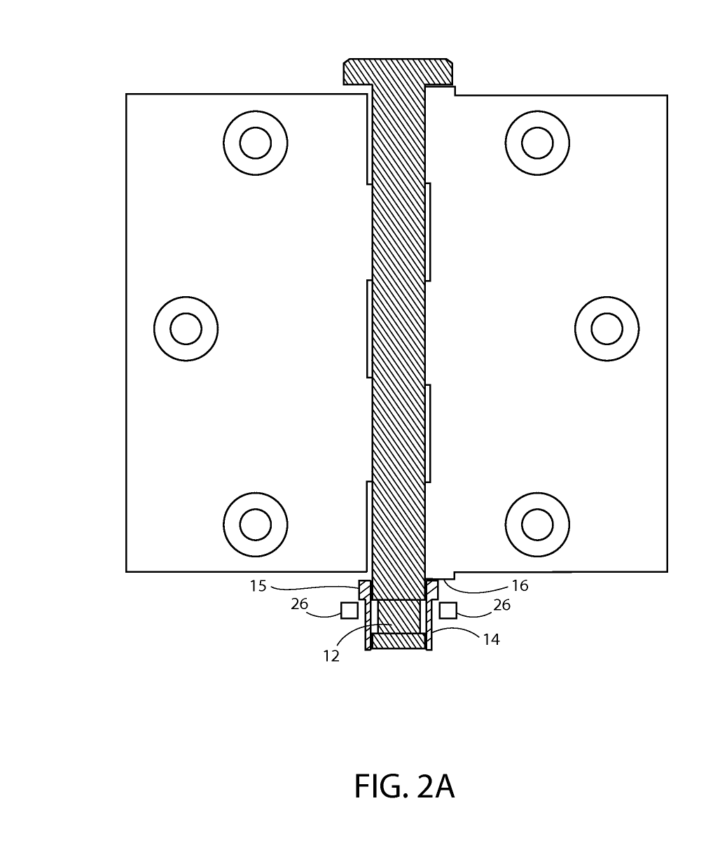

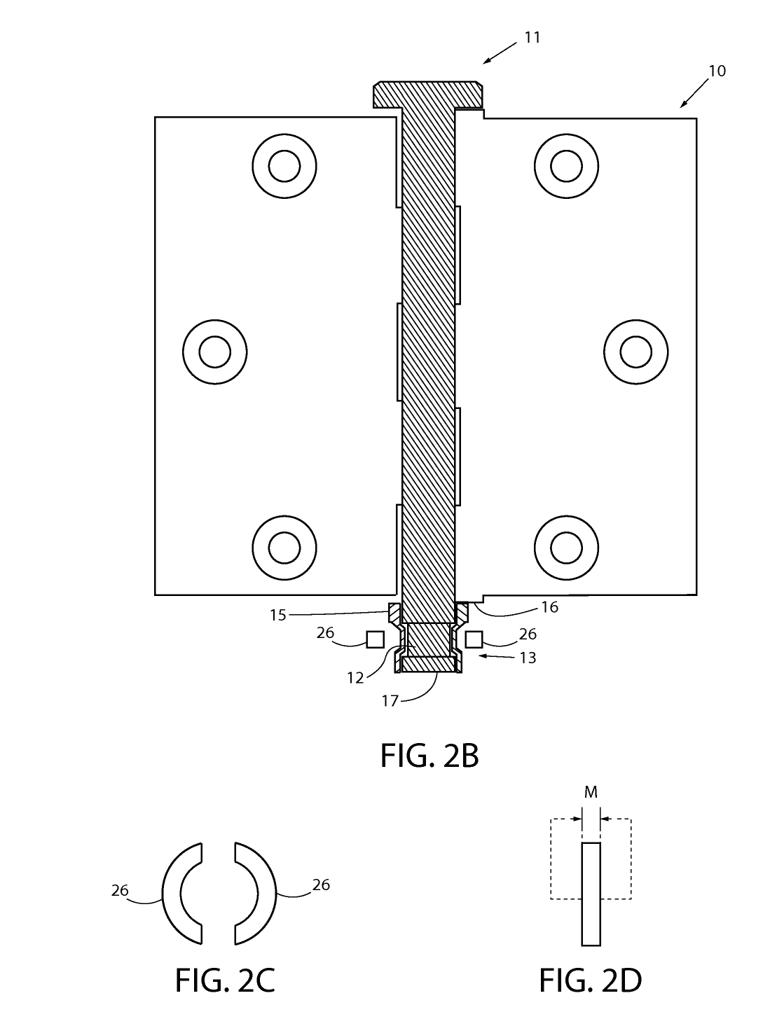

Cut-away views of this assembly are shown in FIGS. 2A and 2B. In FIG. 2A the ferrule or bushing is slid over the extending portion of the pin until the flange portion 15 touches the lowermost portion 16 of the hinge leaf 10B. In FIG. 2B the alignment of the ferrule over the notch is shown predetermined by the height of the hinge and the distance from the head of the pin to the notch. In this figure the ferrule is shown crimped onto the extending portion of the pin in a way that the ferrule is deformed to generally follow the shape of the pin. The crimping is done by radial forces at the pin's annular notch 12 by a crimping die set 26. The die set is seen schematically in a top view in FIG. 2C. The crimp examples shown in these figures are the result of radial forces applied essentially 360-degrees around the ferule. Crimps that apply forces primarily in two or more opposing locations can also be effective.

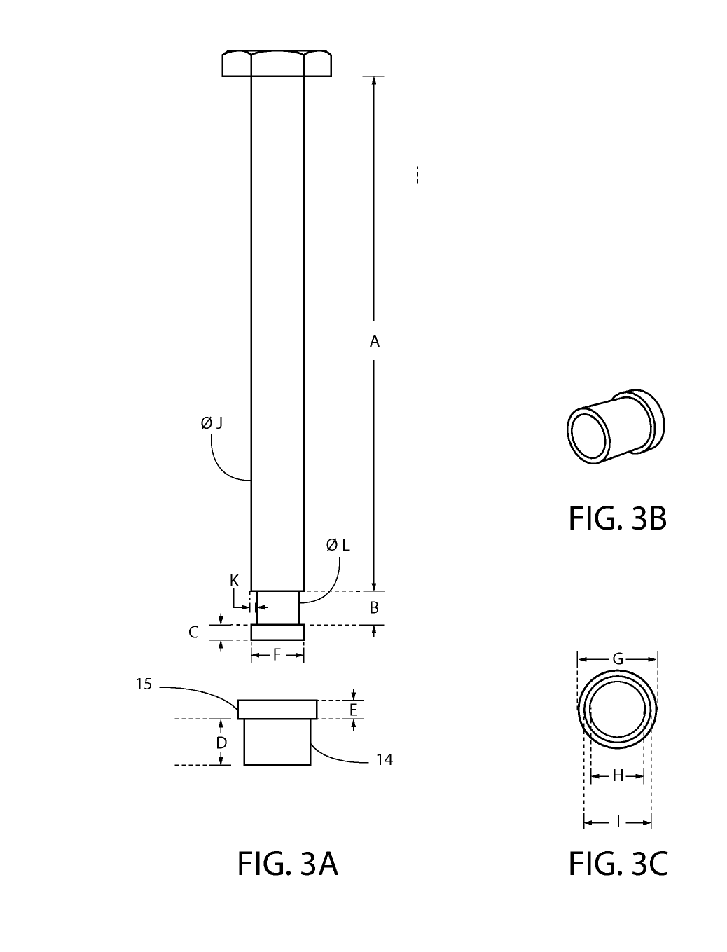

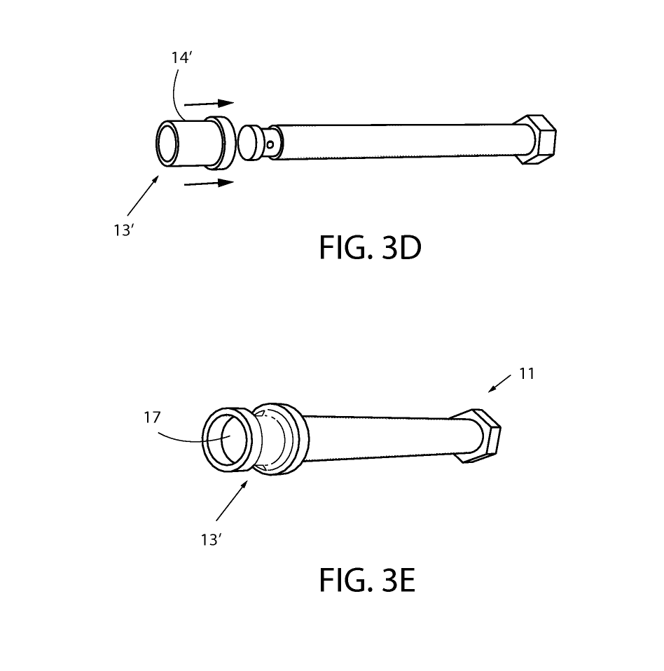

To achieve a tamper resistant application many factors must be have particular relationships to each other. For example, the material of the ferrule, the depth and width of the notch and the wall thickness of the ferrule would be such as to produce a finished assembly with a desired degree of resistance to attempts to remove the pin. FIG. 3A shows a side view of a pin and complementary ferrule.

This ferrule has a sleeve portion 14 and a flange portion 15 as is also seen in FIGS. 3B and 3C. The relative dimensions of depth of notch, length of notch, length of sleeve, and the material of the sleeve collectively determine whether a given assembly will function and, if so, the degree of retention of the ferrule to the pin. A sleeve material that is hard and brittle in combination with a relatively deep notch might fracture when a crimp is attempted. A notch that was relatively short might not afford enough distance for a thick sleeve to be bent to conform to the contours of the pin. Another feature that can increase tamper resistance, particularly in a hinge pin application, is illustrated in the perspective drawings of FIGS. 3D and 3E. The sleeve 14′ of this ferrule 13′ is longer than the sleeve of FIG. 3B. This results in the end of pin 17 being recessed in the sleeve. This recess increases the difficulty of knocking out the hinge pin by hammering its end, since a large hammer will hit the ferrule rather than the recessed pin.

### Installation Steps, First Embodiment

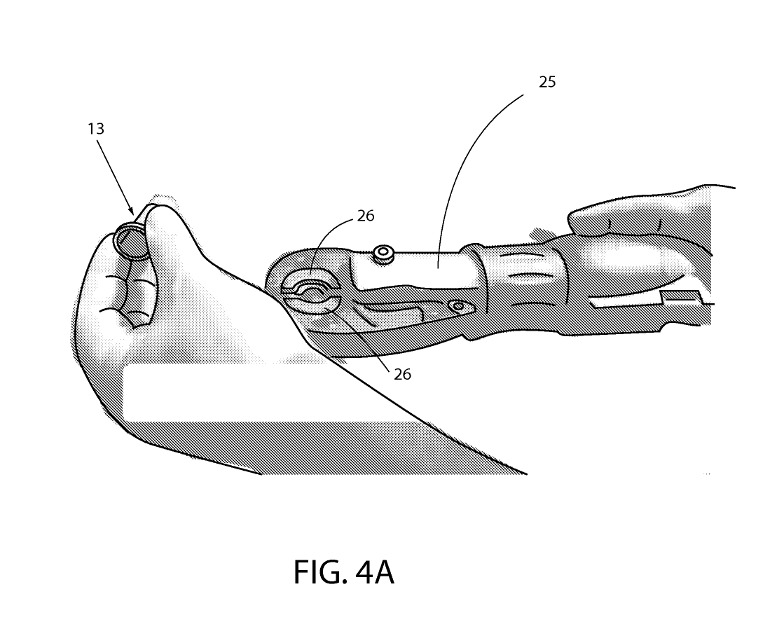

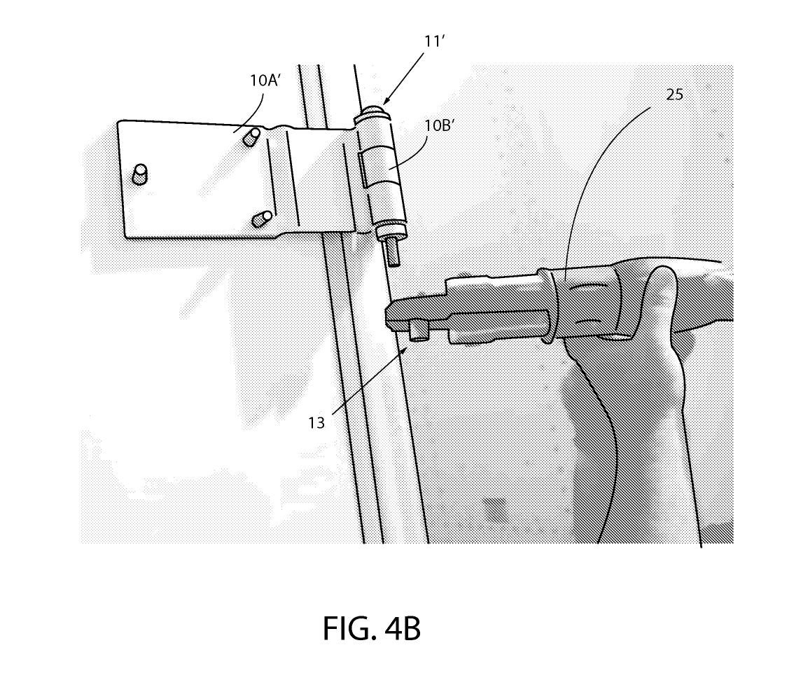

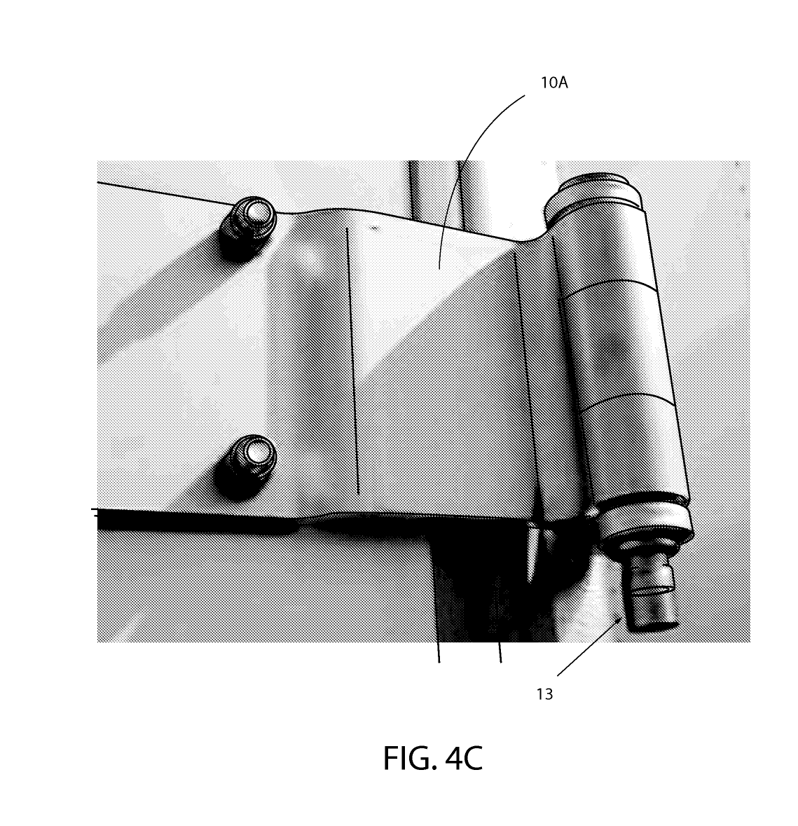

The general use of crimping has been in electrical applications and other applications where the ferrule is strung over a wire, rope, or steel rope prior to crimping. In those typical cases, the crimping tool has no requirement to hold and support the ferrule as a stand-alone component before or during the crimping operation. The ferrule is held in place by virtue of being strung onto a wire. In general, applications of the present teaching do not have a continuous rod or wire threaded through the sleeve. This creates the new problems of holding the ferrule in the tool, aligning the ferrule to a desired location, and holding the ferrule in that location while crimping is accomplished. FIGS. 4A, 4B and 4C show steps of assembling an installation of a specific version of this first embodiment where those problems are solved.

In FIG. 4A a ferrule with a flange, such as the ferrule seen in FIGS. 3B and 3C, is being inserted into a hydraulic crimping tool 25 between the crimping die set 26. By a choice of a complementary sized crimping die, the sleeve portion fits into the space between the dies when the tool is in a closed state. The flange's larger diameter prevents the ferrule from simply falling through. In some applications, as seen in FIG. 4B, this retention can just be by gravity. Alternatively, the die's inner diameter relative to the OD of the sleeve can be such that the sleeve fits in an interference or friction fit. This figure also shows a two-piece butt hinge 10A′ 10B′ (only one side of the hinge is completely visible from this view) with a corresponding pin 11′ inserted and shows the annular notch on the extending portion of the pin.

After the ferrule is placed in the tool, the tool is used to bring the ferrule to the end of the pin as shown in FIG. 4B. In this case the distance from the bottom of the hinge and the start of the notch on the pin is slightly larger then the width E of the flange. This assures that the crimp will repeatedly occur at the desired location on the aligned ferrule and the notch. The post-crimp state is seen in FIG. 4C.

### Details of the Embodiment of FIGS. 4A to 4C

In the interest of presenting a specific example of an implemented and tested embodiment the following table shows the dimensions and specifications of the pin, ferrule, and tool illustrated in FIGS. 4A, 4B and 4C.

| Ref. | Descriptions | Size (inches) |
|---|---|---|
| A | Length of pin to annular notch | 4.9 |
| B | Length of annular notch | 0.325 |
| C | Length of pin portion beyond annular notch | 0.125 |
| D | Length of sleeve portion of ferrule | 0.44 |
| E | Width of flange portion of Ferrule | 0.178 |
| F | Diameter of pin portion beyond notch | 0.5 |
| G | Outer Diameter of flange | 0.75 |
| H | ID of ferrule | 0.5 |
| I | OD of sleeve portion of ferrule | 0.63 |
| J | Diameter of pin above notch | 0.5 |
| K | Depth of notch | 0.045 |
| L | Diameter of the notch | 0.421 |
| M | Thickness of crimp die | 0.19 |

| Component | Material |
|---|---|
| pin | 300 Series Stainless Steel |
| ferrule | 300 Series Stainless Steel |

The die is part number PATJAWSMD6 and the crimp tool shown is model number PATMD6-14V and 6 tons of radial force is used.

### Other Configurations

A group of formulas can help in determining sets of values for these parameters effective in creating a working fastener system. The input values are the diameter of the pin proximate to the groove (PBD) and the thickness of the crimp tool die (TDT)

Pin Basic Diameter=input value (F)

Pin Groove Diameter (PGD)=Pin Basic Diameter (PBD)×0.842 (L)

Pin Groove Width (PGW)=Crimp Tool Die Thickness (TDT)×1.75 (B)

Bushing Overall Length, BOL=PBD×1.25 (G)

Bushing Body Outside Diameter (BOD)=PBD×1.25 (I)

Bushing Inside Diameter (BID)=PBD Min to PBD+PBD×0.001 Max (H)

Bushing Flange Diameter (BFD)=PBD×1.50 (G)

Bushing Flange Thickness (BFT)=PGW×0.20 (E)

### Variations

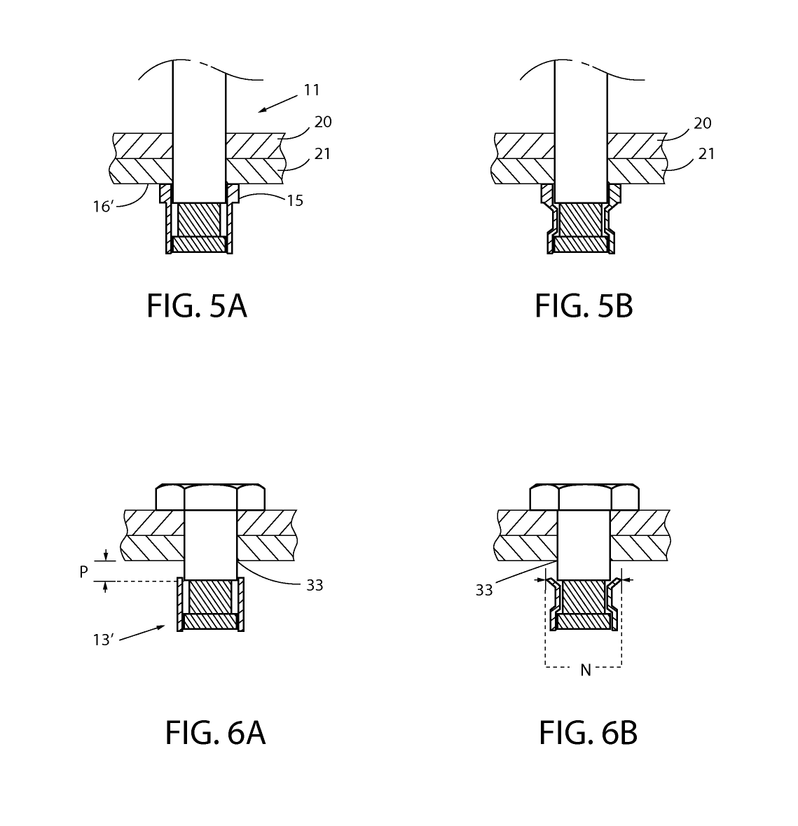

The pin and ferrule scheme of these teachings have application outside of use as a hinge pin. A general application of joining two workpieces without tension is seen in FIGS. 5A and 5B. The pin is shown going through an aperture in an initial workpiece 20 and emerging from an aperture in a final workpiece 21. This is a generalization of the application as a hinge pin. FIG. 5A shows a pre-crimp state and FIG. 5B shows a post-crimp state.

The ferrule 13′ shown in FIGS. 6A and 6B is simply a cylindrical tube. This simple sleeve style ferrule could be less expensive to manufacture than the ferrule with flange in the preceding figures. However, for the pin to be retained the effective diameter N of the ferrule after crimping needs to be large enough that the crimped ferrule interferes with the lowermost opening of the final workpiece 33. The term “effective diameter” is used, because portions of the ferrule extending away from the pin need not be circular to interfere with pin removal from a particular aperture, which may also not be circular. An intermediate component such as a washer might be used to bridge the difference between the diameter N and the diameter of the exit aperture of the final work piece—effectively making the washer the final workpiece.

The FIGs. of 6A and 6B also demonstrate the case of joining two or more work pieces with desired predetermined amount of play. The distance P represents the amount of play in the assembly of 6A and 6B as shown. Spacers could be used to reduce the amount of play. Also, the relative lengths could be increased or reduced to change the amount of play. A desired level of frictional contact could be introduced with appropriate spacing and materials.

### Additional Variations

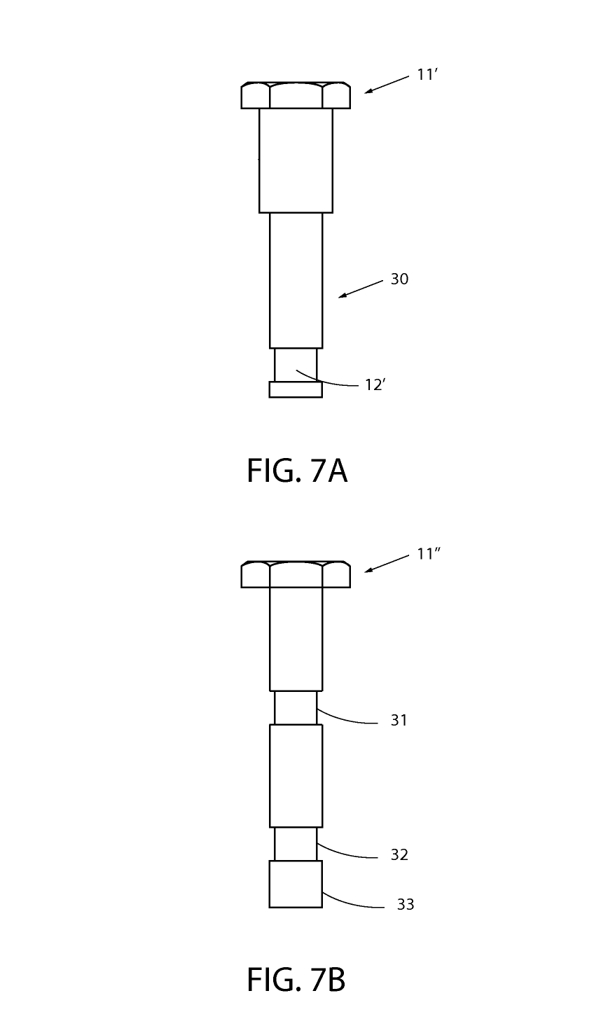

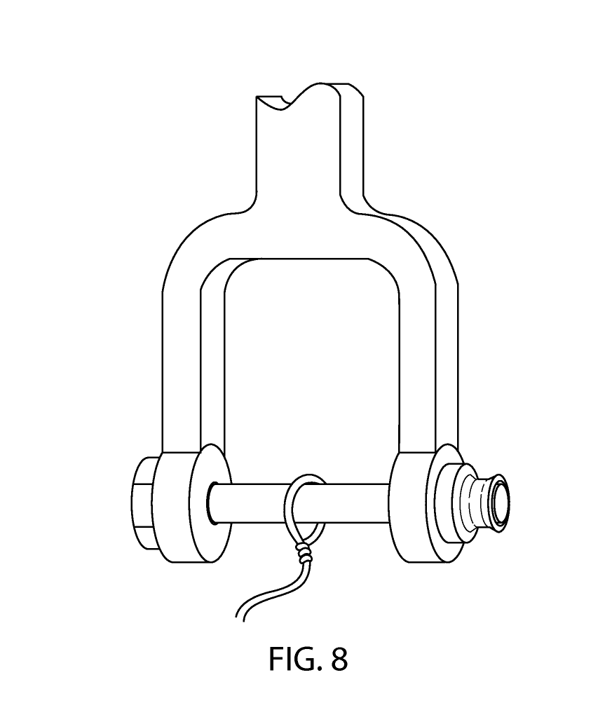

A second set of variations demonstrate that the pin need not have the shape and configuration of pin 11. In FIG. 7A a side view of a pin 11′ is seen as having a larger diameter closer to the head than at the free end. This may be appropriate for certain applications. FIG. 7B demonstrates another variation. The pin 11″ has two annular notches. This provides the option to crimp a ferrule at either location. The variations of FIG. 7A and 7B can be combined producing a pin with multiple crimp locations at different diameters.

### Second Embodiment—Clevis

In some applications a pin may not be holding two or more workpieces together. In the case of a clevis, as seen in FIG. 8, the central region of a pin is used to support one end of a rope. There are no workpieces being held together in this use.

### Third Embodiment—Toy Axle

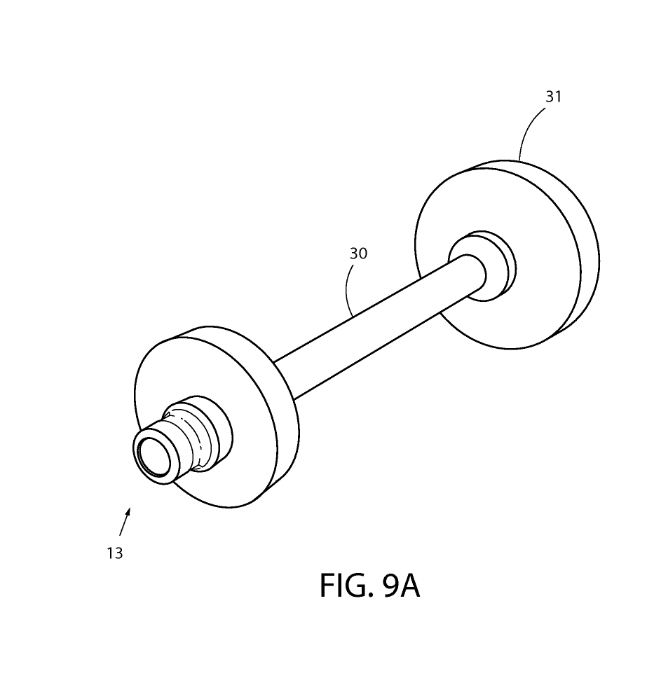

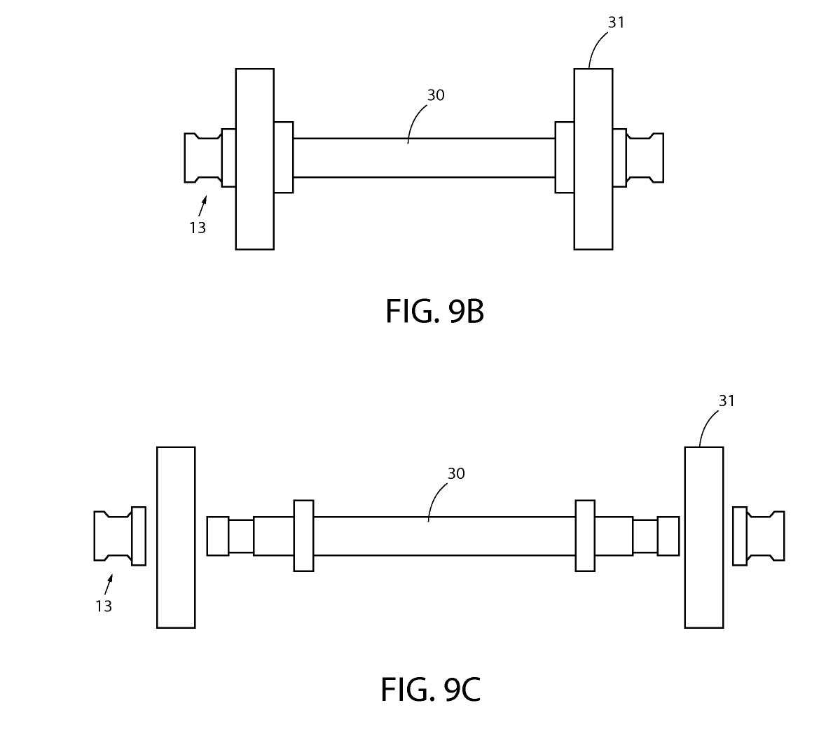

Not all applications involve a pin with a head. A third embodiment is seen in FIG. 9A, FIG. 9B and FIG. 9C where both ends of an axle 30 have annular notches and a pair of wheels 31 are retained on a simple axle buy crimped ferrules 13. This may be a quicker method of terminating the ends of the axel 30, and may reduce the chance of wheels falling off in extended use.

### Fourth Embodiment—Eyeglass Hinges

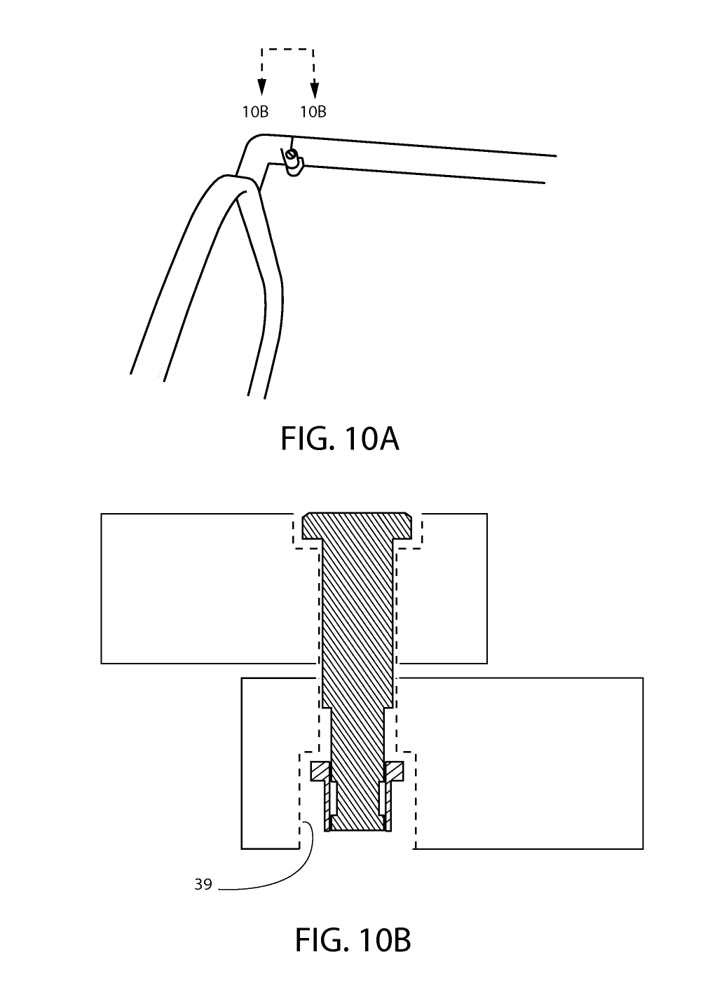

Eyeglass hinges are an example of these teachings being used on a very different scale. The screws that form eyeglass hinge pins often become unscrewed and fall out. A portion of an eyeglass frame, hinge, and earpiece is shown in FIG. 10A. FIG. 10B shows a very expanded cross-section view with the ferrule in an un-crimped state. The recess 39 at the pin's end hides the pin and ferrule in this example.

The use of the terms “a” and “an” and “the” and similar referents in the context of describing the invention are to be construed to cover both the singular and the plural, unless otherwise indicated herein or clearly contradicted by context. The use of any and all examples, or exemplary language (“e.g.” or “such as”) provided herein, is intended merely to better illuminate the invention and does not pose a limitation on the scope of the invention unless otherwise claimed. No language in the specification should be construed as indicating any non-claimed element as essential to the practice of the invention.

It is claimed:

1. A hinge assembly comprising:
a first leaf and a second, complementary leaf of a butt hinge with knuckles interposed;
a pin positioned through the hinge knuckles as to mutually retain the hinge leafs to each other, the pin having a head at one end and a portion at the other end extending beyond the last knuckle, the portion extending beyond the last knuckle having an annular notch; and,
a ferrule with a portion non-elastically deformed into the notch; the ferrule having a flange where the flange has a diameter greater than the inside diameter of the lowermost knuckle and thereby preventing removal of the pin while the ferrule is in place and intact.

2. A fastener assembly comprising:
a pin having an annular notch proximate to a first terminus; and,
a complementary ferrule, the ferrule having an inner diameter such that it slides with a loose fit over the pin from the first terminus to a position over the notch; the length of the ferrule being longer than the width of the notch; further the ferrule composition, ferrule wall thickness, notch width, and notch depth being such that, when over the notch, and two or more opposing radial forces are applied to the ferrule, the ferrule will deform into the notch non-destructively and non-elastically such that a portion of the ferrule will become crimped into the notch in a manner that retains the ferrule to the pin, leaving a portion of the ferrule outside the nominal diameter of a portion of the pin proximate to the notch.

3. The assembly of claim 2 where the retention of the ferrule to the pin is tamper resistant.

4. The assembly of claim 2 where the ferrule is longer than the sum of the width of the notch plus the distance from the notch to the terminus and, when the ferrule is slid onto the pin with the terminus recessed within the ferrule, a ferrule portion suitable for the crimping is positioned over the notch.

5. The assembly of claim 3 where the retention of the ferrule to the pin is tamper resistant and where the pin has a head.

6. The assembly of claim 4 where the pin has a head.

7. An installation comprising:
a pin extending through an aperture in an initial workpiece and extending through an aperture in a final workpiece, and
a ferrule where a portion of the ferrule slid over the extending pin is radially, plastically deformed into an annular notch in the pin; and where the effective diameter of a portion of the deformed ferrule extends beyond the diameter of the pin in the pin region proximate to the notch to the extent that the pin is restricted from being removed from the workpieces by the ferrule interacting with the final workpiece.

8. The installation of claim 7 where the ferrule length, ferrule position and the location of the notch are such that a terminus of the ferrule is abutted to the final workpiece without applying tension to the workpieces.

9. The installation of claim 7 where the ferrule has a flange and the flange is the portion of the ferrule with the largest effective diameter.

10. The installation of claim 7 where the ferrule length, ferrule position and the location of the notch are such that a terminus of the pin is recessed within the ferrule.

11. The installation of claim 7 where the workpieces comprise a hinge.

12. The installation of claim 8 where the ferrule has a flange and the flange is the portion of the ferrule abutted to the final workpiece.

13. The installation of claim 8 where the ferrule length, ferrule position and the location of the notch are such that a terminus of the ferrule is recessed within the ferrule.

14. The installation of claim 11 further comprising the hinge.

15. The installation of claim 9 where the workpieces comprise a hinge.

16. A method of retaining a hinge pin comprising:
a. inserting a pin through the pivot point of a hinge where the pin extends beyond the hinge;
b. sliding a ferrule over the portion of the pin that extends to a location on the pin with an annular notch of a predetermined width that is greater than the length of the ferrule; and
c. crimping the ferrule at a point generally central to the notch with opposing radial forces where no axial force is required and such that the ferrule is retained to the pin, a portion of the ferrule becomes or maintains a state where the ferrule portion extends beyond the diameter of the pin such that removal of the pin from the hinge is interfered with.

17. The method of retaining a hinge pin of claim 16 where the retention of the ferrule to the pin is tamper resistant.

18. The method of retaining a hinge pin of claim 16 where the terminus of the ferrule adjacent to the hinge is abutted to the hinge in a non-tensioned manner that allows free movement of the hinge around the pin.

19. The method of retaining a hinge pin of claim 16 where the location and length of the pin is such that the pin end is recessed within the ferrule.

20. The method of retaining a hinge pin of claim 17 where the location and length of the pin is such that a recess for the pin end is provided within the ferrule.
